(19) United States
(12) Patent Application Publication
(10) Pub. No.: US 2015/0099074 A1
(43) Pub. Date: Apr. 9, 2015

(54) BODY BAG

(71) Applicant: BioSeal Systems, San Diego, CA (US)

(72) Inventor: Edward L. McWilliams, San Diego, CA (US)

(73) Assignee: BioSeal Systems, San Diego, CA (US)

(21) Appl. No.: 14/048,740

(22) Filed: Oct. 8, 2013

(51) Int. Cl. B32B 1/02

(52) U.S. Cl. CPC B32B 1/02
USPC 428/34.3

(57) ABSTRACT

The invention comprises a body bag having at least two layers of a sheet material and a paper sheet, with the sheet material being a plastic coated on at least a portion with adhesive, the coating of adhesive cause the sheet material to stick only to itself. The paper sheet is adjacent to the plastic sheet material to initially prevent the sheet material from sticking to itself.

### TECHNICAL FIELD

This invention relates to containers for human or animal remains, and more particularly to body bags or cadaver containment bags.

### BACKGROUND OF THE INVENTION

When a person or animal dies and needs to be transported or stored for a short time, the remains are generally placed within a body bag or cadaver pouch. Transporting and securing such remains can present a challenge. It is often necessary to conceal the remains from view, and care should be taken to prevent contact of the remains with accompanying personnel. Also one must be able to easily insert the remains into the container. In addition, the body bag must be strong and resilient enough to facilitate lifting, moving, and otherwise carrying the remains.

A further requirement is that the body bag must not damage the body in any way, as the mortician will have difficulty altering or repairing such damage.

### SUMMARY OF THE INVENTION

In a broad aspect, the invention involves a body bag or containment device that includes a rectangular length of plastic that has an accompanying similarly sized length of paper. The plastic substrate has a contact adhesive on at least one side. The adhesive sticks only to itself, and not to the paper, a user, or the surface on which it may sit. The plastic/paper combination may be provided in a roll or as discrete lengths. It is cut by a user to a desired size, and laid on a flat surface. The body is then placed on the flat plastic/paper. A first side of the plastic/paper is pulled over the body and the plastic separated from the paper and allowed to hang on one side. The second side of the plastic/paper is then pulled over the body and the first side. The plastic is separated from the paper on the second side and the two plastic sides are brought together and crumpled into a rectangular tight mass on all four sides. The result is a compact body bag.

More specifically, the method of using a body bag includes the steps of providing a desired length of a plastic sheet coated with an adhesive, the plastic sheet being adjacent a paper sheet, and the length having opposing ends. Next, the plastic sheet and adjacent paper sheet is placed on a flat surface. A body is placed on the desired length of coated plastic sheet so as to allow a first and second width of the coated plastic sheet and paper sheet to be on respective sides of the body. A first width of the coated plastic sheet and paper sheet is pulled over the body. The first width is separated into a first coated plastic sheet and a first paper sheet and the first coated plastic sheet is positioned away from the body. The second width of coated plastic sheet and paper sheet is pulled over the body. The second width of the coated plastic sheet is separated into a second coated plastic sheet and a second paper sheet and the second coated plastic sheet is drawn away from the body. The edges of the first and second coated plastic sheets are brought to together to cause the first and second coated plastic sheets to adhere to each other. The opposing ends are then cramped together and sealed.

The accompanying figures, where like reference numerals refer to identical or functionally similar elements throughout the separate views and which together with the detailed description below are incorporated in and form part of the specification, serve to further illustrate on embodiment and to explain various principles and advantages all in accordance with the present invention.

### CONCISE DESCRIPTION OF THE DRAWINGS

FIG. 1 is a top plan view of the body bag of the subject invention.

FIG. 2 is a cross section of the body bag of the subject invention.

FIG. 3 is a perspective view of a roll of the two-ply material of the subject invention.

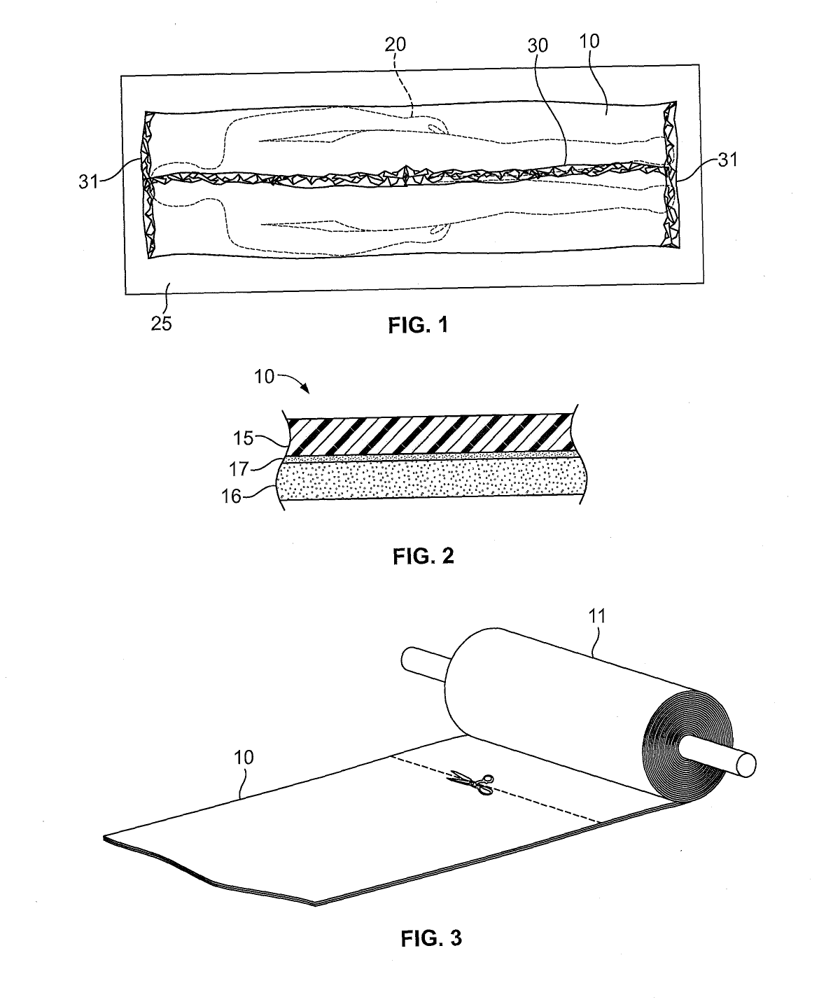

### DETAILED DESCRIPTION OF ONE EMBODIMENT OF THE INVENTION

While the present invention is susceptible of embodiment in various forms, there is shown in the drawings a presently preferred embodiment that is discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of one Embodiment of the Invention”) relates to a requirement of the United States Patent Office, and should not be found to limit the subject matter disclosed herein.

An embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The body bag of the subject invention includes at least two layers of a sheet material and a paper sheet, the sheet material being plastic, the plastic having at least an edge portion thereof being coated with an adhesive, the coating of adhesive causing the sheet material to stick only to itself, the paper sheet being adjacent said sheet material to initially prevent said sheet material from sticking to itself.

Referring now to FIG. 3, there is shown a roll 11 of the material 10 of the subject invention. The material is preferably 96 inches long and 80 inches wide. As shown, the material 10 may be supplied rolled up and subsequently cut to the desired length by a user. Alternatively, the sheet material may be precut to a desired length, such as 96 inches, and folded into a convenient size, such as 18 inch by 18 inch. The user may then cut the material 10 to the desired length. The sheet material is polyethylene, preferably a linear low density polyethylene (LLDPE).

The material 10 is a laminate of 2 or more layers (FIG. 2). A first layer or substrate 15 is plastic and may comprise polyethylene sheeting, polyethylene laminates to woven or nonwoven support fabrics, or varying weights of supported and unsupported polyvinyl chloride (PVC) and/or polyurethane. Other materials may comprise polyvinyl chloride, chlorinated polyethylene, chlorinated butyl, polyethylene, high density polyethylene, low density polyethylene, linear low density polyethylene, polypropylene, polyurethane, PTFE, combinations thereof, or multiple-layered coextruded films which include one or more layers of ethylene-vinyl acetate, ethylene vinyl alcohol, polyvinyl alcohol, nylon, Surlyn®, or polyester. Preferably the plastic layer is LLDPE.

The second layer 17, bonded to the first layer is a contact adhesive that will adhere to itself, and the first layer, but not to a paper spacer 16 that is placed adjacent the adhesive coating or a user's skin. The paper serves as a separation to avoid the plastic/adhesive combination from sticking to itself. The paper may be kraft paper or other inexpensive paper or cellulosic material. The adhesive is a pressure sensitive latex cohesive, preferably a polyisoprene and styrene butadiene elastomer blend, i.e., an SBR latex. This adhesive does not adhere to the body or any of its parts, such as hair, skin, or nails, when it comes into contact with it, but will adhere to itself. Thus, damage to the body is avoided when in the body bag of the subject invention.

The method of the subject invention for using a body bag includes the steps of providing a desired length of a plastic sheet coated with an adhesive, the plastic sheet being adjacent a paper sheet, the length having opposing ends, placing the plastic sheet and adjacent paper sheet on a flat surface, placing a body on the desired length of coated plastic sheet so as to allow a first and second width of the coated plastic sheet and paper sheet to be on opposite sides of the body, pulling the first width of the coated plastic sheet and paper sheet over the body, separating the first width into a first coated plastic sheet and a first paper sheet and drawing the first coated plastic sheet away from the body, pulling the second width of coated plastic sheet and paper sheet over the body, separating the second width of the coated plastic sheet into a second coated plastic sheet and a second paper sheet and drawing the second coated plastic sheet away from the body, bringing the first and second coated plastic sheets together and causing the first and second coated plastic sheets to adhere to each other; and, sealing the opposing ends.

The method of preparing a body bag for wrapping body remains in the body bag of the subject invention can also involve, providing a length of two ply sheet, the length having opposing ends, a first ply being plastic, and a second ply being paper, the first ply having contact adhesive thereon; laying the length on a surface; placing body remains on said length; separating the first ply from the second ply on a first side of the body and positioning the first ply away from the body; separating the first ply from the second ply on a second side of body and joining the first ply from the first side of the body with the first ply from the second side of the body; adhesively securing the first ply from the first side to the first ply from the second side; and, sealing said opposing ends.

More specifically, the method of the subject invention comprises cutting the sheet material described above to a desired length, and placing it on a flat surface 25. A body 20 that is to be covered and enclosed is placed on the sheet material and longitudinally aligned with the sheet material 10.

The plastic sheet material has adhesive applied to at least a 6-12 inch strip on the plastic at the edges thereof,

The paper layer is drawn across the body on one side and separated from the adhesive coated plastic sheet material. This action is repeated for the opposite side. The adhesive coated sheet material is then folded back over the body and folded at the ends to create a double thickness of about 6 inches wide. This action is repeated with the opposite side which is then brought over into contact with the double thickness of the first side, from the head to the foot of the body, drawn together and crushed to form a tight mass 30 in a type of roll. Next the end portions of the adhesive coated sheet material, i.e., on the longitudinal ends, are brought together in general alignment and crushed to form a tight roll 31. All three of these rolls are squeezed and tightened to the extent possible. Because the adhesive coated sheet material sticks to itself, the tight roll thus assembled maintains both sides of the sheet together with sufficient adhesion to keep the two sides together. The thus assembled body bag may then be used to retain human or animal bodies for extended periods, and may be used for transport of the body. The adhesive permits the plastic sheet material to stick to itself with sufficient force and sealing capability to maintain about 10 psi pressure within the bag.

It will be understood that the foregoing description is of preferred exemplary embodiments of the invention and that the invention is not limited to the specific forms shown or described herein. Various modifications may be made in the design, arrangement, and type of elements disclosed herein, as well as the steps of making and using the invention without departing from the scope of the invention as expressed in the appended claims.

1. A body bag comprising at least two layers of a sheet material and a paper sheet, said sheet material being plastic, said plastic having at least an edge portion thereof being coated with an adhesive, said coating of adhesive causing the sheet material to stick only to itself, said paper sheet being adjacent said sheet material to initially prevent said sheet material from sticking to itself.

2. The body bag of claim 1 wherein said paper sheet is kraft paper.

3. The body bag of claim 1 wherein said adhesive is a contact adhesive.

4. The body bag of claim 1 wherein said adhesive is a polyisoprene and styrene butadiene elastomer blend.

5. The body bag of claim 1 wherein said sheet material is linear low density polyethylene.

6. The body bag of claim 1 wherein said sheet material is polyethylene.

7. A method of preparing a body bag for wrapping body remains in the body bag, comprising the steps of:
1) providing a length of two ply sheet, said length having opposing ends, a first ply being plastic, and a second ply being paper, said first ply having contact adhesive thereon;
2) laying said length on a surface;
3) placing body remains on said length;
4) separating the first ply from the second ply on a first side of the body and positioning the first ply away from the body;
5) separating the first ply from the second ply on a second side of body and joining the first ply from the first side of the body with the first ply from the second side of the body;
6) adhesively securing the first ply from the first side to the first ply from the second side; and, sealing said opposing ends.

8. A method of using a body bag including the steps of:
providing a length of a plastic sheet coated with an adhesive, said plastic sheet being adjacent a paper sheet, said length having opposing ends;
Placing the plastic sheet and adjacent paper sheet on a flat surface;
Placing a body on the length of coated plastic sheet so as to allow a first and second width of the coated plastic sheet and paper sheet to be on opposite sides of the body;
Pulling the first width of the coated plastic sheet and paper sheet over the body;
Separating the first width into a first coated plastic sheet and a first paper sheet and drawing the first coated plastic sheet away from the body;
Pulling the second width of coated plastic sheet and paper sheet over the body;
Separating the second width of the coated plastic sheet into a second coated plastic sheet and a second paper sheet and drawing the second coated plastic sheet away from the body;
Bringing the first and second coated plastic sheets together and causing the first and second coated plastic sheets to adhere to each other; and,
Sealing said opposing ends.
